(19) United States
(12) Patent Application Publication
(10) Pub. No.: US 2013/0257768 A1
(43) Pub. Date: Oct. 3, 2013

(54) METHOD AND APPARATUS FOR PROVIDING FLEXIBLE BEZEL

(71) Applicant: SAMSUNG ELECTRONICS CO. LTD., Suwon-si (KR)

(72) Inventors: Wee-Hyuk LEE, Gumi-si (KR); Jang-Woo LEE, Gumi-si (KR)

(73) Assignee: SAMSUNG ELECTRONICS CO. LTD., Suwon-si (KR)

(21) Appl. No.: 13/804,353

(22) Filed: Mar. 14, 2013

(30) Foreign Application Priority Data
Mar. 30, 2012 (KR) 10-2012-0032886

(51) Int. Cl. G06F 3/041

(52) U.S. Cl. CPC G06F 3/0416
USPC 345/173

(57) ABSTRACT

A method and an apparatus for providing a flexible bezel in an apparatus including a touch screen display are provided. The method includes detecting dragging of a boundary line of a touch screen on the touch screen of the touch screen display, moving the boundary line according to the dragging, and setting a touch screen area located between the moved boundary line and a default boundary line as a bezel area.

### PRIORITY

This application claims the benefit under 35 U.S.C. §119(a) of a Korean patent application filed on Mar. 30, 2012 in the Korean Intellectual Property Office and assigned Serial No. 10-2012-0032886, the entire disclosure of which is hereby incorporated by reference.

### BACKGROUND OF THE INVENTION

1. Field of the Invention

The present invention relates to an apparatus including a touch screen display. More particularly, the present invention relates to an apparatus and a method for providing a bezel associated with a touch screen display.

2. Description of the Related Art

A touch screen display may provide a User Interface (UI) through a touch screen. The touch screen display may display graphics and text on the touch screen, and may detect and respond to a touch on the touch screen. A device employing the touch screen display may display one or more soft keys, menus, and other UI objects on the touch screen. Users may touch a location corresponding to a UI object on the touch screen so as to provide an input associated with the UI object to the device employing the touch screen display.

The touch screen display may be employed by a portable device, such as a laptop computer, a tablet computer, a mobile phone, a smartphone, a Personal Digital Assistant (PDA), and the like, and may also be employed by a desktop computer. There has been an increasing demand for a portable device having a wider screen and smaller hardware.

The portable device having the touch screen display may include a fixed hardware bezel formed around the touch screen display. Due to the fixed hardware bezel, a screen that is smaller than a size of the portable device may be displayed. Users may demand a device having a wider screen when devices have the same size. Accordingly, attempts to narrow or remove a width of the bezel have continued.

However, when a user holds the portable device including the touch screen display with their hand, unintentional touches on the touch screen may frequently occur as the bezel area becomes narrower. For example, when a user performs web browsing through use of the portable device, the user's palm or finger may escape the bezel area irrespective of the user's intention, and may touch the touch screen that provides a UI.

Therefore, a need exists for an apparatus and a method for adaptively providing a width of a bezel based on settings of a user in an apparatus including a touch screen display.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a method and an apparatus for providing a flexible bezel in an apparatus including a touch screen display.

Another aspect of the present invention is to provide a method and an apparatus for adaptively providing a width of a bezel based on settings of a user in an apparatus including a touch screen display.

Another aspect of the present invention is to provide a method and an apparatus for improving the portability of an apparatus including a touch screen display, and providing a wide screen for user convenience.

Another aspect of the present invention is to provide a method and an apparatus for preventing an unintentional touch on a touch screen in a portable apparatus including a touch screen display.

In accordance with an aspect of the present invention, a method of providing a flexible bezel in an apparatus including a touch screen display is provided. The method includes detecting dragging of a boundary line of a touch screen on the touch screen of the touch screen display, moving the boundary line according to the dragging, and setting a touch screen area located between the moved boundary line and a default boundary line as a bezel area.

In accordance with another aspect of the present invention, a method of providing a flexible bezel in an apparatus including a touch screen display is provided. The method includes detecting dragging of a boundary line of at least one side of a touch screen of the touch screen display, moving the boundary line of the at least one side, including the side corresponding to the dragging, according to the dragging, and setting a touch screen area located between the moved boundary line and a default boundary line as a bezel area.

In accordance with another aspect of the present invention, an apparatus for providing a flexible bezel is provided. The apparatus includes a touch screen display, and a controller configured to move a boundary line according to a dragging and to set a touch screen area located between the moved boundary line and a default boundary line as a bezel area, when the dragging of the boundary line of a touch screen is detected on the touch screen of the touch screen display.

In accordance with another aspect of the present invention, an apparatus for providing a flexible bezel is provided. The apparatus includes a touch screen display, and a controller configured to move a boundary line of at least one side including a side corresponding to dragging according to the dragging and to set a touch screen area located between the moved boundary line and a default boundary line as a bezel area when the dragging of the boundary line of the at least one side of the touch screen is detected on the touch screen of the touch screen display.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal including a flexible bezel according to an exemplary embodiment of the present invention;

FIG. 2 is a diagram illustrating a touch screen of a mobile terminal including a flexible bezel according to an exemplary embodiment of the present invention;

FIG. 3 is a flowchart illustrating a process of providing a flexible bezel according to an exemplary embodiment of the present invention; and

FIGS. 4A through 10B are diagrams illustrating a flexible bezel according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Terms throughout the specifications may be defined based on the functions of the invention and thus, the terms may be differently defined based on the intentions of operators, conventions, and the like. Therefore, the definition may be construed based on the entire invention.

In the following description, the same elements will be designated by the same reference numerals although they are shown in different drawings.

While the exemplary embodiments of the present invention will be described with reference to a mobile terminal as an example, the exemplary embodiments may be applicable to other devices having a similar technical background. It will be understood by those skilled in the art that the invention may be applicable to other devices by making a few changes without departing from the scope of the invention. That is, although an apparatus is different from a mobile terminal, the exemplary embodiments of the present invention may be applicable to the apparatus when the apparatus includes a touch screen display. For example, the exemplary embodiments of the present invention may be applicable to various portable electronic devices, such as a Motion Pictures Expert Group-1 (MPEG-1) Audio Layer-3 (MP3) player, a Portable Multimedia Player (PMP), a digital camera, and the like, and may be applicable to a desktop computer, a television (TV), and the like, when the devices include touch screen displays.

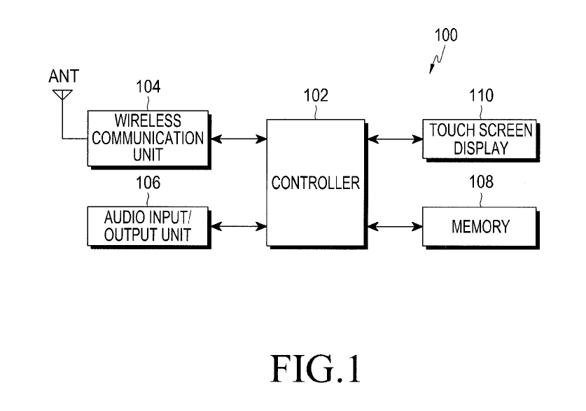

FIGS. 1 through 10B, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of a mobile terminal including a flexible bezel according to an exemplary embodiment of the present invention.

Referring to FIG. 1, a mobile terminal 100 may be, for example, a laptop computer, a tablet computer, a mobile phone, a smartphone, a Personal Digital Assistant (PDA), and the like. The mobile terminal 100 may include a controller 102, a wireless communication unit 104, an audio input/output unit 106, a memory 108, and a touch screen display 110.

The wireless communication unit 104 may perform transmission and reception of a wireless signal for a mobile communication service of the mobile terminal 100. The audio input/output unit 106 may input and output various audio signals associated with operations of the controller 102. The memory 108 may store a program for the operations of the controller 102, and may store various data associated with operation of the controller 102. The memory 108 may further include an external memory, and a storage device, such as a Hard Disk Drive (HDD). A touch screen display 110 may be a User Interface (UI) between the mobile terminal 100 and a user, which provides an input interface and an output interface. The touch screen display 110 may display a screen associated with an operation of the controller 102 on a touch screen, and may provide a user input to the controller 102 by touching the touch screen.

The mobile terminal 100 may further include another input unit in addition to the touch screen display 110, for example, a keypad or a hardware key. The mobile terminal 100 may further include another communication unit in addition to the wireless communication unit 104, for example, a wired and wireless communication unit, such as a Universal Serial Bus (USB), a Local Area Network (LAN), a Bluetooth, and the like.

The controller 102 may perform general functions of the mobile terminal 100, and may control the touch screen display 110 so as to provide a flexible bezel when a bezel setting mode is turned on. The bezel setting mode is a mode for providing the flexible bezel and may be turned on and off by the user through a menu, an icon, and the like, in the same manner as other general user setting modes that may be turned on and off by the user of the mobile terminal 100. The mobile terminal 100 may provide the flexible bezel when the bezel setting mode is turned on, and may not provide the flexible bezel when the bezel setting mode is turned off. In an exemplary implementation, the bezel setting mode may be set as a default, as opposed to enabling the user to turn on and off the bezel setting mode.

The controller 102 may detect dragging of a boundary line of the touch screen, on the touch screen of the touch screen display 110. The controller 102 may move the boundary line corresponding to the dragging according to the dragging, and may set a touch screen area located outside the moved boundary line as a bezel area. In general, dragging may refer to a gesture of a user that touches a point on the touch screen with a finger or a device, such as a stylus, and holds down the finger or the device touching the point while moving the finger or the device to another point.

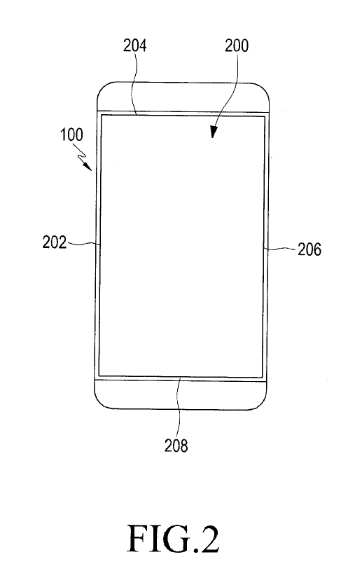

FIG. 2 is a diagram illustrating a touch screen of a mobile terminal including a flexible bezel according to an exemplary embodiment of the present invention.

Referring to FIG. 2, instead of a fixed hardware bezel set for the mobile terminal 100, a bezel area may be set on a touch screen 200 of the touch screen display 110. FIG. 2 illustrates a state before the bezel area is set. In addition, FIG. 2 illustrates an example where the touch screen 200 is in a quadrangular shape, and particularly in a rectangular shape. Accordingly, the touch screen 200 may have four sides.

A user may drag one of the boundary lines 202 through 208 of the four sides of the touch screen 200, or drag two or more boundary lines of the boundary lines 202 through 208, so as to set the bezel area. The boundary lines 202 through 208 may be default boundary lines. Dragging a boundary line on the touch screen 200 may be performed by touching the touch screen 200 through use of a finger of the user or a stylus in the same manner as usual. In general, when the user performs dragging on a touch screen using a finger, in most cases only a single finger or two fingers may be used. Three fingers, for example, a thumb, an index finger, and middle finger, may be used together, or four fingers or five fingers may be used together for dragging. However, taking into consideration a structure of a human's hand, the user may perform dragging of one of the boundary lines 202 through 208 of the touch screen 200, or may perform dragging of two or three boundary lines together. Dragging of two or three boundary lines may include dragging of a vertex of boundary lines.

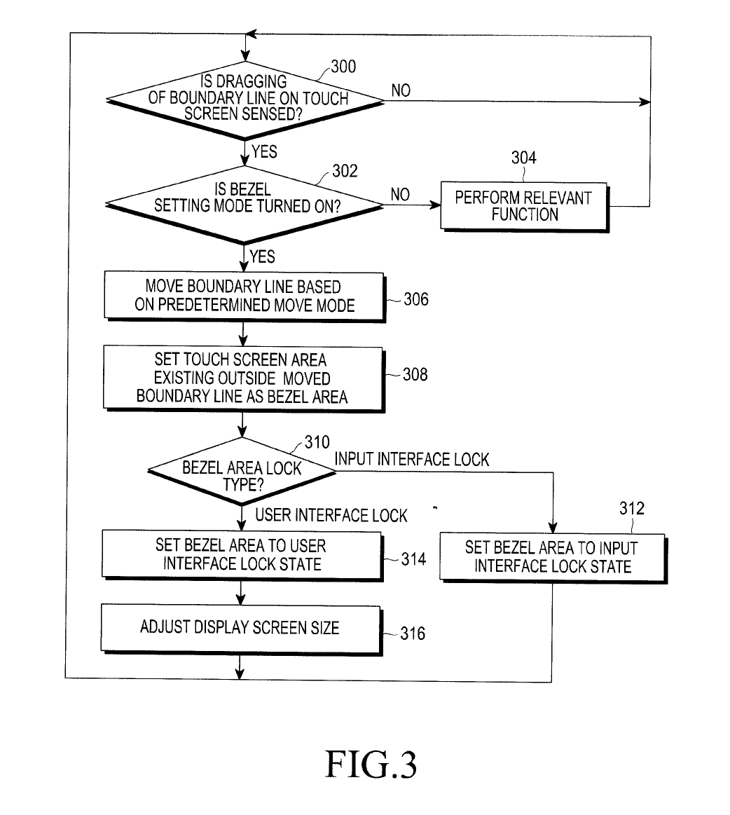

FIG. 3 is a flowchart illustrating a process of providing a flexible bezel according to an exemplary embodiment of the present invention.

Referring to FIG. 3, when dragging of at least one of the boundary lines 202 through 208 is detected through the touch screen display 110 in step 300, the controller 102 may proceed with step 302. Dragging associated with the boundary lines 202 through 208 may include dragging of one of the boundary lines 202 through 208 or dragging of two or three of the boundary lines 202 through 208, as described in the foregoing. Therefore, when two or three boundary lines are dragged together in step 300, the controller 102 may detect the dragged boundary lines by distinguishing a number of the dragged boundary lines and a type of the dragged boundary lines. A technology that detects a single dragging or simultaneously and discretely detects two or more draggings on the touch screen may be apparent to those skilled in the art and thus, a description thereof will be omitted. In exemplary embodiments of the present invention, irrespective of which point of a boundary line is touched by the user, the boundary line including the touched point is considered to be dragged.

In step 302, the controller 102 may determine whether the bezel setting mode is turned on. When the bezel setting mode is turned off, the controller 102 may proceed with step 304, and when the bezel setting mode is turned on, the controller 102 may proceed with step 306. In step 304, the controller 102 may perform a general dragging-relevant function, and may return to step 300.

The controller 102 may move at least one of the boundary lines based on a predefined move mode in step 306, and may set a touch screen area located outside the moved boundary line as a bezel area in step 308. A pattern of setting the bezel area based on the dragging associated with the boundary lines 202 through 208 may be variously changed based on a type of dragged boundary line from among the boundary lines 202 through 208, a number of dragged boundary lines, a number of moved boundary lines according to the dragging, and a direction of the dragging.

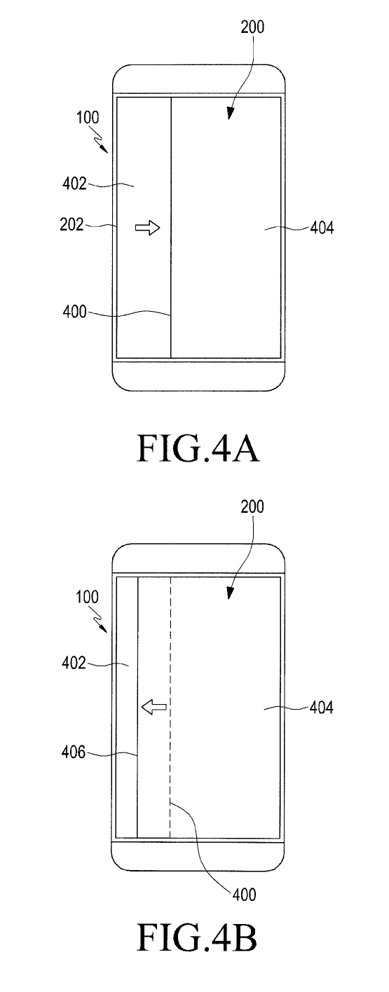

FIGS. 4A through 10B are diagrams illustrating various patterns of a flexible bezel according to exemplary embodiments of the present invention. Referring to FIGS. 4A through 10B, steps 306 through 308 will be described.

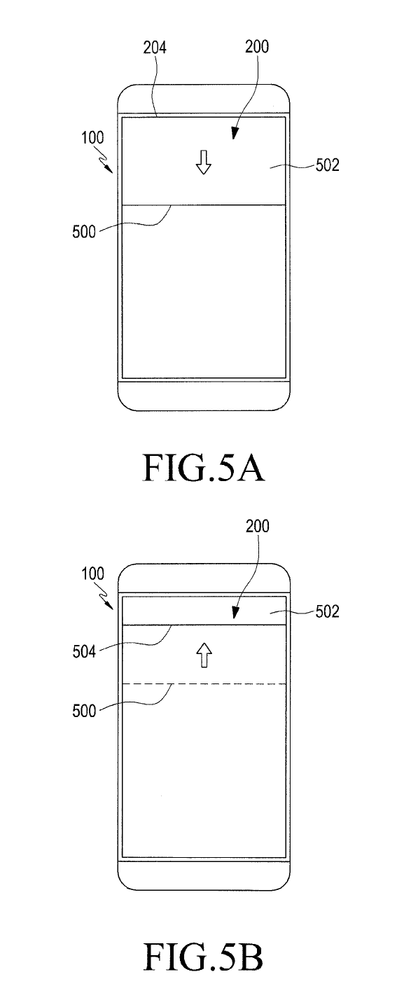

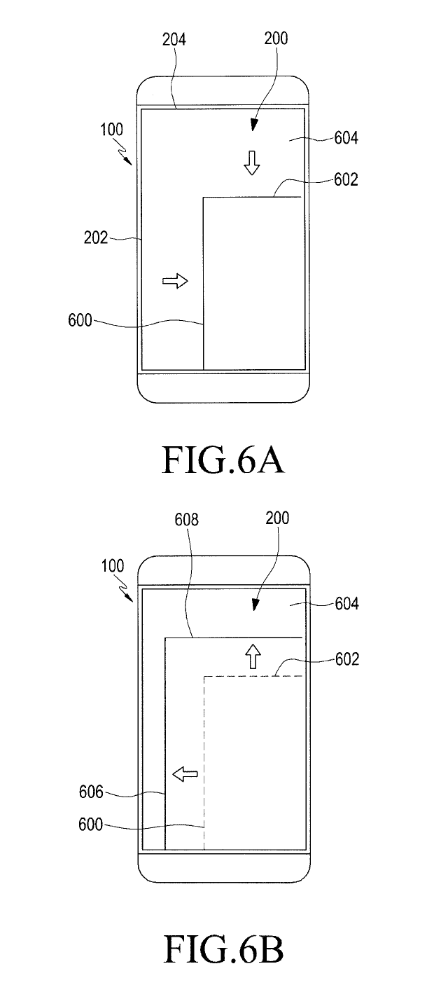

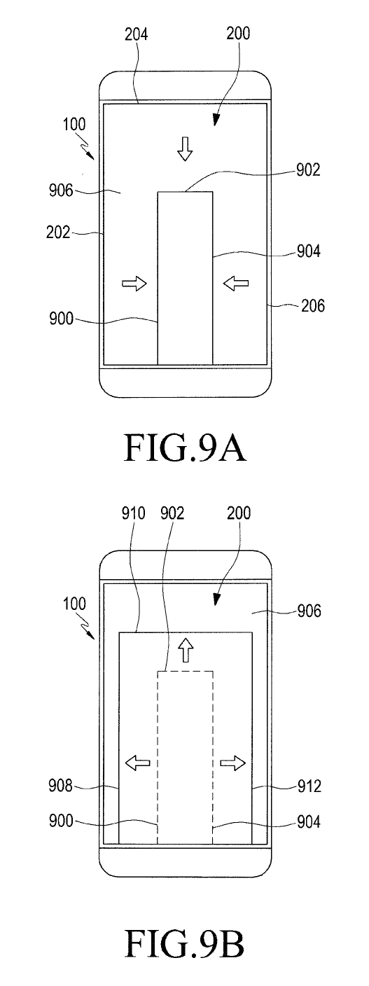

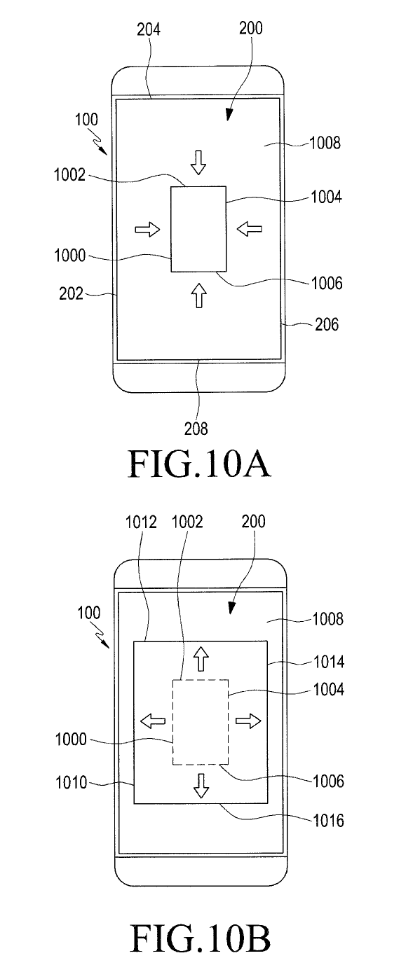

FIGS. 4A through 5B illustrate a case in which one of the boundary lines 202 through 208 of FIG. 2 is moved. FIGS. 6A through 8B illustrate a case in which two of the boundary lines 202 through 208 of FIG. 2 are moved. FIGS. 9A and 9B illustrate a case in which three of the boundary lines 202 through 208 of FIG. 2 are moved. FIGS. 10A and 10B illustrate a case in which four of the boundary lines 202 through 208 of FIG. 2 are moved. Throughout the exemplary embodiments of the present invention to be described with reference to FIGS. 4A through 10B, for ease of description, a direction of dragging on the touch screen 200 and a direction of movement of a boundary line may be distinguished as an upper direction, a lower direction, a left direction, and a right direction, which are determined based on a point of view of a viewer of the drawings.

Referring to FIGS. 4A and 4B, one boundary line 202 of the boundary lines 202 through 208 of FIG. 2 is moved. When the boundary line 202 in the state of FIG. 2 is dragged by the user in the right direction of the touch screen, the controller 102 may move the boundary line 202 according to the dragging, as shown in FIG. 4A. A boundary line 400 of FIG. 4A may correspond to a moved boundary line of the boundary line 202. In FIG. 4A, an arrow aiming from the left side to the right side may indicate a direction of movement of a boundary line, which is the same in FIGS. 4B through 10B. The controller 102 may set a touch screen area located between the boundary line 400 and the boundary line 202 corresponding to the boundary line 400 as a bezel area 402.

The boundary line 400 in the state of FIG. 4A may be dragged by the user in the left direction or the right direction of the touch screen 200. When the boundary line 400 in the state of FIG. 4A is dragged by the user in the right direction of the touch screen 200, the boundary line 400 may be moved in the same manner as the change from the state of FIG. 2 to the state of FIG. 4A, and accordingly, a width of the changed bezel area 402 may become wider than that of FIG. 4A.

Conversely, when the boundary line 400 in the state of FIG. 4A is dragged by the user in the left direction of the touch screen 200, the controller 102 may move the boundary line 400 according to the dragging, as shown in FIG. 4B. A boundary line 406 of FIG. 4B may correspond to a moved boundary line of the boundary line 400. The controller 102 may set a touch screen area located between the boundary line 406 and the boundary line 202 corresponding to the boundary line 406 as the bezel area 402. Accordingly, the width of the bezel area 402 may become narrower than that of FIG. 4A.

Referring to FIGS. 5A and 5B, one boundary line 204 of the boundary lines 202 through 208 of FIG. 2 is moved. When the boundary line 204 in the state of FIG. 2 is dragged by the user in the lower direction of the touch screen 200, the controller 102 may move the boundary line 204 according to the dragging, as shown in FIG. 5A. A boundary line 500 in FIG. 5A may correspond to a moved boundary line of the boundary line 204. The controller 102 may set a touch screen area located between the boundary line 500 and the boundary line 204 corresponding to the boundary line 500 as a bezel area 502.

The boundary line 500 in the state of FIG. 5A may be dragged by the user in the upper direction or the lower direction of the touch screen 200. When the boundary line 500 in the state of FIG. 5A is dragged by the user in the lower direction of the touch screen 200, the boundary line 500 may be moved in the same manner as the change from the state of FIG. 2 to the state of FIG. 5A, and accordingly, a width of the bezel area 502 may become wider than that of FIG. 5A.

Conversely, when the boundary line 500 in the state of FIG. 5A is dragged in the upper direction of the touch screen 200, the controller 102 may move the boundary line 500 according to the dragging, as shown in FIG. 5B. A boundary line 504 in FIG. 5B may correspond to a moved boundary line of the boundary line 500. The controller 102 may set a touch screen area located between the boundary line 504 and the boundary line 204 corresponding to the boundary line 504 as the bezel area 502, and accordingly, a width of the bezel area 502 may become narrower than that of FIG. 5A.

Although another boundary line from among the boundary lines 202 through 208 of FIG. 2, for example, the boundary line 206 or the boundary line 208, may be moved, this may be readily understood by those skilled in the art based on the descriptions provided with reference to FIGS. 4A through 5B and thus, descriptions thereof will be omitted.

Referring to FIG. 6A and FIG. 6B, two connected boundary lines 202 and 204 from among the boundary lines 202 through 208 of FIG. 2 are moved. When the boundary line 202 is dragged by the user in the right direction of the touch screen 200 or the boundary line 204 is dragged in the lower direction of the touch screen 200, in the state of FIG. 2, the controller 102 may move the boundary lines 202 and 204 according to the dragging, as shown in FIG. 6A. A boundary line 600 of FIG. 6A may correspond to a moved boundary line of the boundary line 202, and a boundary line 602 may correspond to a moved boundary line of the boundary line 204. The controller 102 may set a touch screen area located between the boundary lines 600 and 602 and the boundary lines 202 and 204 corresponding to the boundary lines 600 and 602 as a bezel area 604.

In the state of FIG. 6A, the boundary line 600 may be dragged by the user in the left direction or the right direction of the touch screen 200, or the boundary line 602 may be dragged in the upper direction or the lower direction of the touch screen 200. When the boundary line 600 is dragged by the user in the right direction of the touch screen 200 or the boundary line 602 is dragged in the lower direction of the touch screen 200, in the state of FIG. 6A, the boundary lines 600 and 602 may be moved in the same manner as the change from the state of FIG. 2A to the state of FIG. 6A and a width of the bezel area 604 may become wider than that of FIG. 6A.

Conversely, when the boundary line 600 is dragged by the user in the left direction of the touch screen 200 or the boundary line 602 is dragged in the upper direction of the touch screen 200, in the state of FIG. 6A, the controller 102 may move the boundary lines 600 and 602 according to the dragging, as shown in FIG. 6B. A boundary line 606 of FIG. 6B may correspond to a moved boundary line of the boundary line 600 and a boundary line 608 may correspond to a moved boundary line of the boundary line 602. The controller 102 may set a touch screen area located between the boundary lines 606 and 608 and the boundary lines 202 and 204 corresponding to the boundary lines 606 and 608 as the bezel area 604. Accordingly, the width of the bezel area 604 may become narrower than that of FIG. 6A.

Although two other boundary lines from among the boundary lines 202 through 208 of FIG. 2, excluding the two boundary lines 202 and 204 moved in FIGS. 6A and 6B, for example, the boundary lines 204 and 206, boundary lines 206 and 208, or boundary lines 202 and 208, may be moved, this may be readily understood by those skilled in the art based on the descriptions provided with reference to FIGS. 6A through 6B and thus, descriptions thereof will be omitted.

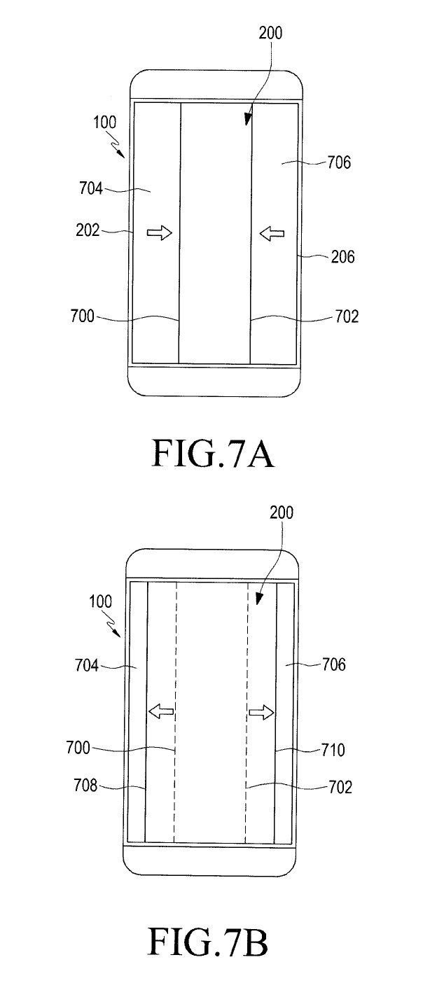

Referring to FIGS. 7A and 7B, two subtend boundary lines 202 and 206 from among the boundary lines 202 through 208 of FIG. 2 are moved. When the boundary line 202 is dragged by the user in the right direction of the touch screen 200 or the boundary line 206 is dragged in the left direction of the touch screen 200, in the state of FIG. 2, the controller 102 may move the boundary lines 202 and 206 according to the dragging, as shown in FIG. 7A. A boundary line 700 of FIG. 7A may correspond to a moved boundary line of the boundary line 202 and a boundary line 702 may correspond to a moved boundary line of the boundary line 206. The controller 102 may set touch screen areas located between the boundary lines 700 and 702 and the boundary lines 202 and 206 corresponding to the boundary lines 700 and 702 as bezel areas 704 and 706, respectively.

In the state of FIG. 7A, one of the boundary lines 700 and 702 may be dragged in the left direction or the right direction of the touch screen 200. When the boundary line 700 is dragged by the user in the right direction of the touch screen 200 or the boundary line 702 is dragged in the left direction of the touch screen 200, in the state of FIG. 7A, the boundary lines 700 and 702 may be moved in the same manner as the change from the state of FIG. 2 to the state of FIG. 7A, and widths of the bezel areas 704 and 706 may become wider than those of FIG. 7A.

Conversely, when the boundary line 700 is dragged by the user in the left direction of the touch screen 200 or the boundary line 702 is dragged in the right direction of the touch screen 200, in the state of FIG. 7A, the controller 102 may move the boundary lines 700 and 702 according to the dragging, as shown in FIG. 7B. A boundary line 708 of FIG. 7B may correspond to a moved boundary line of the boundary line 700 and a boundary line 710 may correspond to a moved boundary line of the boundary line 702. The controller 102 may set touch screen areas located between the boundary lines 708 and 710 and the boundary lines 202 and 206 corresponding to the boundary lines 708 and 710 as the bezel areas 704 and 706, respectively. Accordingly, the width of the bezel areas 704 and 706 become narrower than those of FIG. 7A.

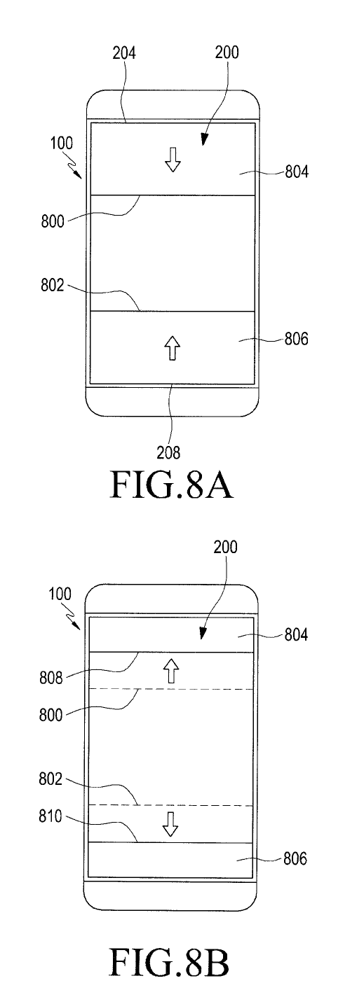

Referring to FIGS. 8A and 8B, two subtend boundary lines 204 and 208 from among the boundary lines 202 through 208 of FIG. 2 are moved. When the boundary line 204 is dragged by the user in the lower direction of the touch screen 200 or the boundary line 208 is dragged in the upper direction of the touch screen 200, in the state of FIG. 2, the controller 102 may move the boundary lines 204 and 208 according to the dragging, as shown in FIG. 8A. A boundary line 800 of FIG. 8A may correspond to a moved boundary line of the boundary line 204 and a boundary line 802 may correspond to a moved boundary line of the boundary line 208. The controller 102 may set touch screen areas located between the boundary lines 800 and 802 and the boundary lines 204 and 208 corresponding to the boundary lines 800 and 802 as bezel areas 804 and 806, respectively.

In the state of FIG. 8A, one of the boundary lines 800 and 802 may be dragged by the user in the upper direction or the lower direction of the touch screen 200. When the boundary line 800 is dragged by the user in the lower direction of the touch screen 200 or the boundary line 802 is dragged in the upper direction of the touch screen 200, in the state of FIG. 8A, the boundary lines 800 and 802 may be moved in the same manner as the change from the state of FIG. 2 to the state of FIG. 8A, and widths of the bezel areas 804 and 806 may become wider than those of FIG. 8A.

Conversely, when the boundary line 800 is dragged by the user in the upper direction of the touch screen 200 or the boundary line 802 is dragged in the lower direction of the touch screen 200, in the state of FIG. 8A, the controller 102 may move the boundary lines 800 and 802 according to the dragging, as shown in FIG. 8B. A boundary line 808 of FIG. 8B may correspond to a moved boundary line of the boundary line 800, and a boundary line 810 may correspond to a moved boundary line of the boundary line 802. The controller 102 may set touch screen areas located between the boundary lines 808 and 810 and the boundary lines 204 and 208 corresponding to the boundary lines 808 and 810 as the bezel areas 804 and 806, respectively. Accordingly, the widths of the bezel areas 804 and 806 may become narrower than those of FIG. 8A.

Referring to FIGS. 9A and 9B, three boundary lines 202 through 206 from among the boundary lines 202 through 208 are moved. When the boundary line 202 is dragged by the user in the right side of the touch screen 200, the boundary line 204 is dragged in the lower direction of the touch screen 200, or the boundary line 206 is dragged in the left direction of the touch screen 200, in the state of FIG. 2, the controller 102 may move boundary lines 202 through 206 according to the dragging, as shown in FIG. 9A. A boundary line 900 of FIG. 9A may correspond to a moved boundary line of the boundary line 202, a boundary line 902 may correspond to a moved boundary line of the boundary line 204, and a boundary line 904 may correspond to a moved boundary line of the boundary line 206. The controller 102 may set a touch screen area located between the boundary lines 900 through 904 and the boundary lines 202 through 206 corresponding to the boundary lines 900 through 904 as a bezel area 906.

In the state of FIG. 9A, one of the boundary lines 900 and 904 may be dragged in the left direction or the right direction of the touch screen 200 or the boundary line 902 may be dragged in the upper direction or the lower direction of the touch screen 200. When the boundary line 900 is dragged by the user in the right direction of the touch screen 200, the boundary line 902 is dragged in the lower direction of the touch screen 200, or the boundary line 904 is dragged in the left direction of the touch screen 200, in the state of FIG. 9A, the boundary lines 900 through 904 may be moved in the same manner as the change from the state of FIG. 2 to the state of FIG. 9A, and a width of the bezel area 906 may become wider than that of FIG. 9A.

Conversely, when the boundary line 900 is dragged by the user in the left direction of the touch screen 200, the boundary line 902 is dragged in the upper direction, or the boundary line 904 is dragged in the right direction, in the state of FIG. 9A, the controller 102 may move the boundary lines 900 through 904 according to the dragging, as shown in FIG. 9B. A boundary line 908 of FIG. 9B may correspond to a moved boundary line of the boundary line 900, a boundary line 910 may correspond to a moved boundary line of the boundary line 902, and a boundary line 912 may correspond to a moved boundary line of the boundary line 904. The controller 102 may set a touch screen area located between the boundary lines 908 through 912 and the boundary lines 202 through 206 corresponding to the boundary lines 908 through 912 as the bezel area 906. Accordingly, the width of the bezel area 906 may become narrower than that of FIG. 9A.

Although three other boundary lines from among the boundary lines 202 through 208 of FIG. 2, excluding the boundary lines 202 through 206, for example, the boundary lines 204 through 208 or boundary lines 202, 206, and 208, may be moved, this may be readily understood by those skilled in the art based on the descriptions provided with reference to FIGS. 9A through 9B and thus, descriptions thereof will be omitted.

Referring to FIGS. 10A and 10B, all the boundary lines 202 through 208 of FIG. 2 are moved. When the boundary line 202 is dragged by the user in the right direction of the touch screen 200, the boundary line 204 is dragged in the lower direction of the touch screen 200, the boundary line 206 is dragged in the left direction of the touch screen 200, or the boundary line 208 is dragged in the upper direction of the touch screen 200, in the state of FIG. 2, the controller 102 may move the boundary lines 202 through 208 according to the dragging, as shown in FIG. 10A. A boundary line 1000 of FIG. 10A may correspond to a moved boundary line of the boundary line 202, a boundary line 1002 may correspond to a moved boundary line of the boundary line 204, a boundary line 1004 may correspond to a moved boundary line of the boundary line 206, and a boundary line 1006 may correspond a moved boundary line of the boundary line 208. The controller 102 may set a touch screen area located between the boundary lines 1000 through 1006 and the boundary lines 202 through 208 corresponding to the boundary lines 1000 through 1006 as a bezel area 1008.

In the state of FIG. 10A, one of the boundary lines 1000 and 1004 may be dragged by the user in the left direction or the right direction of the touch screen 200, or one of the boundary lines 1002 and 1006 may be dragged in the upper direction or the lower direction of the touch screen 200. When the boundary line 1000 is dragged by the user in the right direction of the touch screen 200, the boundary line 1002 is dragged in the lower direction of the touch screen 200, the boundary line 1004 is dragged in the left direction of the touch screen 200, or the boundary line 1006 is dragged in the upper direction of the touch screen 200, the boundary lines 1000 through 1006 may be moved in the same manner as the change from the state of FIG. 2 to the state of FIG. 10A, and a width of the bezel area 1008 may become wider than that of FIG. 10A.

Conversely, when the boundary line 1000 is dragged by the user in the left direction of the touch screen 200, the boundary line 1002 is dragged in the upper direction of the touch screen 200, the boundary line 1004 is dragged in the right direction of the touch screen 200, or the boundary line 1006 is dragged in the lower direction of the touch screen 200, the controller 102 may move the boundary lines 1000 through 1006 according to the dragging, as shown in FIG. 10B. A boundary line 1010 of FIG. 10B may correspond to a moved boundary line of the boundary line 1000, a boundary line 1012 may correspond to a moved boundary line of the boundary line 1002, a boundary line 1014 may correspond to a moved boundary line of the boundary line 1004, and a boundary line 1016 may correspond to a moved boundary line of the boundary line 1006. The controller 102 may set a touch screen area located between the boundary lines 1010 through 1016 and the boundary lines 202 through 208 corresponding to the boundary lines 1010 through 1016 as the bezel area 1008. Accordingly, the width of the bezel area 1008 may become narrower than that of FIG. 10A.

As described in the foregoing with reference to FIGS. 4A through 10B, when one of the boundary lines 202 through 208 is dragged, movement of the boundary line corresponding to dragging may be classified as the following first through fifth move modes:

A first move mode: move only a boundary line of a dragged side.

A second move mode: move a boundary line of a dragged side and a boundary line of one of the sides connected to the dragged side.

A third move mode: move a boundary line of a dragged side and a boundary line of a subtend side of the dragged side.

A fourth move mode: move a boundary line of a dragged side, a boundary line of one of the sides connected to the dragged side, and a subtend boundary line of the dragged side, or move the boundary line of the dragged side and two boundary lines of two sides connected to the dragged side.

A fifth move mode: move all boundary lines of sides of a touch screen.

Among FIGS. 4A through 10B, FIGS. 4A through 5B correspond to the first move mode, FIGS. 6A and 6B correspond to the second move mode, FIGS. 7A through 8B correspond to the third move mode, FIGS. 9A and 9B correspond to the fourth move mode, and FIG. 10A and FIG. 10B correspond to the fifth move mode.

When two of the boundary lines 202 through 208 of the touch screen 200 are dragged together, moving boundary lines and setting a bezel area may be performed in substantially the same manner as FIGS. 6A through 10B. When two of the boundary lines 202 through 208 are dragged together, movement of the boundary lines corresponding to the dragging may be classified as the following first through third move modes:

A first move mode: move only boundary lines of two dragged sides.

A second move mode: move boundary lines of two dragged sides and a boundary line of one of the sides connected to the two dragged sides.

A third move mode: move all boundary lines of sides of a touch screen.

The first move mode associated with dragging two boundary lines may be similar to FIGS. 6A through 8B in that the boundary lines are moved like FIGS. 6A through 8B. However, the first move mode associated with dragging two boundary lines may be different from FIGS. 6A through 8B in that both moved boundary lines are dragged boundary lines. The second move mode associated with dragging two boundary lines may be similar to FIGS. 9A and 9B in that the boundary lines are moved like FIGS. 9A and 9B. However, the second move mode associated with dragging two boundary lines may be different from FIGS. 9A and 9B in that two of the three moved boundary lines are dragged boundary lines. The third move mode associated with dragging two boundary lines may be similar to FIGS. 10A and 10B in that the boundary lines are moved like FIGS. 10A and 10B. However, the third move mode associated with dragging two boundary lines may be different from FIGS. 10A and 10B in that two of the four moved boundary lines may be dragged boundary lines.

When three of the boundary lines 202 through 208 of the touch screen 200 are dragged together, moving boundary lines and setting a bezel area may be performed in substantially the same manner as FIGS. 9A through 10B. When three of the boundary lines 202 through 208 are dragged together, movement of the boundary lines corresponding to the dragging may be classified as the following first and second move modes:

A first move mode: move only three dragged boundary lines.

A second move mode: move all boundary lines of sides of a touch screen.

The first move mode associated with dragging three boundary lines may be similar to FIGS. 9A and 9B in that the boundary lines may be moved like FIGS. 9A and 9B. However, the first move mode associated with dragging three boundary lines may be different from FIGS. 9A and 9B in that all the three moved boundary lines may be dragged boundary lines. The second move mode associated with dragging three boundary lines may be similar to FIGS. 10A and 10B in that the boundary lines may be moved like FIGS. 10A and 10B. However, the second move mode associated with dragging three boundary lines may be different from FIGS. 10A and 10B in that three of the four moved boundary lines may be dragged boundary lines.

One of the first through fifth move modes associated with dragging a single boundary line may be set to be a move mode selected by the user in advance. The user of the mobile terminal 100 may set the move mode through a menu, an icon, and the like, in the same manner as a general user setting mode that is selectively set by the user. In addition, one of the first through fifth move modes may be set as a default. In the same manner, one of the first through third move modes associated with dragging two boundary lines, and one of the first and second move modes associated with dragging three boundary lines may be set.

From among the movement of a boundary line and bezel area setting associated with dragging a single boundary line, the movement of boundary lines and bezel area setting associated with dragging two boundary lines, and the movement of boundary lines and bezel area setting associated with dragging three boundary lines, one or two cases or all the three cases may be selectively set, by the user, to be performed or may be set as a default.

A location of a moved boundary line corresponding to dragging may be determined to be substantially the same as a location to which a dragged object is to be relocated according to general dragging. For example, the location of the moved boundary line may be determined to correspond to an end point of dragging or to a dragging speed. When two or more boundary lines are dragged together, locations of the moved boundary lines may be determined to correspond to a boundary line that is moved a farther distance than other dragged boundary lines or to a boundary line that is moved a shorter distance than other dragged boundary lines. In addition, when two or more boundary lines are dragged together, the locations of the moved boundary lines may be determined to correspond to a boundary line that is moved faster than other dragged boundary lines, to a boundary line that is moved slower than other dragged boundary lines, or to an average moving speed.

To prevent a boundary line from being excessively moved, a maximum distance that the boundary line is able to move may be limited. For example, although the user performs dragging of a boundary line beyond a horizontal center line or a vertical center line of the touch screen 200, movement of the boundary line may be limited to the horizontal center line or the vertical center line of the touch screen 200.

Referring again to FIG. 3, the controller 102 may move a boundary line based on a predefined move mode and may set a bezel area in steps 306 through 308, as described with reference to FIGS. 4A through 10B, and may proceed with step 310. In step 310, the controller 102 may determine a currently set bezel area lock type.

When the bezel area lock type is set to input interface lock, the controller 102 may set a bezel area set as illustrated in FIGS. 4A through 10B to an input interface lock state in step 312, and may return to step 300. Conversely, when the bezel area lock type is set to user interface lock, the controller 102 may set the bezel area set as illustrated in FIGS. 4A through 10B to a user interface lock state in step 314.

The bezel area lock type may be classified into input interface lock and user interface lock. The input interface lock may refer to locking an input interface through a bezel area, and the user interface lock may refer to locking an input interface and an output interface through a bezel area. When the bezel area is set to the user interface lock state, the controller 102 may not receive an input associated with touching on the bezel area, and may not output a screen through the bezel area. Accordingly, the bezel area of the touch screen 200 may appear to be black. Conversely, when the bezel area is set to the user interface lock state, a background screen set by the user or determined as a default may be output through the bezel area. When the bezel area is set to the input interface lock state, the controller 102 may not receive an input associated with touching on the bezel area, but may normally output a screen through the bezel area.

For the mobile terminal 100, one of the input interface lock and the user interface lock may be selectively set by the user or one of the bezel area lock types may be set as a default. In an exemplary implementation, only one of the input interface lock and the user interface lock may be applied.

When the bezel area is set to the user interface lock state in step 314, the screen may not be output through the bezel area and thus, the controller 102 may adjust a display screen size of the touch screen display 110 in step 316. For example, the display screen size may be adjusted to match a size of a remaining area excluding the bezel area from the touch screen 200. Referring to FIG. 4A, a display screen size may need to be decreased to match a size of the area 404 so that the remaining area 404 excluding the bezel area 402 from the touch screen 200 may be output through the screen. When the state is changed from the state of FIG. 4A to the state of FIG. 4B, the area 404 of FIG. 4A may be enlarged to FIG. 4B and thus, the display screen size may be enlarged to match the size of the area 404 of FIG. 4B. After step 316, the controller 102 may return to step 300.

Exemplary embodiments of the present invention may provide a flexible bezel that is embodied in a software manner, as opposed to a fixed hardware bezel and thus, a bezel having a desired width may be adaptively provided based on settings of a user.

Accordingly, for a screen of the same size, a size of a portable apparatus may be smaller than before. In other words, for a portable apparatus of the same size, a size of a screen may be larger than before. Therefore, a portability of the portable apparatus may be improved, and a wide screen may be provided for user convenience.

In addition, ease of grip may be maximized when the user uses the portable apparatus.

Furthermore, an unintentional touch on a touch screen may be prevented when the user performs web browsing, and the like, and a maximum screen display may be provided when the user views a video clip, and the like.

Although the exemplary embodiments of the present invention have described a case in which the touch screen 200 of the touch screen display 110 is in a quadrangular shape, it is apparent to those skilled in the art that the exemplary embodiments may be applicable when a touch screen is in a polygonal shape that is different from the quadrangular shape, or in a circular shape. When the touch screen is in a shape different from the quadrangular shape, a number of boundary lines may be changed and thus, movement of a boundary line and bezel area may need to be set to correspond to the change. Those skilled in the art may readily understand the movement of the boundary line and bezel area setting based on the descriptions of FIGS. 4A through 10B.

The above-described exemplary embodiments of the invention may be embodied as hardware, software or a combination of hardware and software. Software may be stored in a volatile or non-volatile storage device, such as a Read Only Memory (ROM) and a Random Access Memory (RAM) irrespective of erasing or rewriting, or a storage medium that is capable of performing optical or magnetic recording and machine-reading, such as a Compact Disc (CD), a Digital Versatile Disc (DVD), a magnetic disc, a magnetic tape, and the like. A memory that may be included in a mobile terminal may be an example of machine-readable storage media that are suitable for storing a program including instructions to implement the exemplary programs of the present invention. Therefore, exemplary embodiments of the present invention may include a program including a code to implement an apparatus or a method of the present invention, and a machine-readable storage medium including the program. The program may be transferred electronically through a medium, such as a communication signal transferred through a wired or wireless connection, and exemplary embodiments of the present invention may appropriately include an equivalent medium.

The flexible bezel providing method may be manufactured as a program so as to be stored in a storage medium. A mobile terminal equipped with a touch screen display may execute the program by installing or downloading the program (for example, an application) to provide the flexible bezel, from a program providing device (for example, a program providing server), and may use the program for providing the flexible bezel. When the program to be used for providing the flexible bezel is installed in the mobile terminal, the program may be executed in the mobile terminal, and may provide the flexible bezel. The program providing device may transmit the program to the mobile terminal in response to a request for transmitting the program from the mobile terminal, or may transmit the program to the mobile terminal automatically. The program providing device may additionally perform determining whether the mobile terminal is a subscriber of the service, user authentication, confirmation of payment, and the like. The program providing device may include a communication unit to perform wired or wireless communication with the mobile terminal, a storage medium to store the program, and a controller to transmit the program to the mobile terminal through the communication unit. In addition, the storage medium may be included in the program providing device or may exist outside the program providing device.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of providing a flexible bezel in an apparatus including a touch screen display, the method comprising:
detecting dragging of a boundary line of a touch screen on the touch screen of the touch screen display;
moving the boundary line according to the dragging; and
setting a touch screen area located between the moved boundary line and a default boundary line as a bezel area.

2. The method of claim 1, wherein the moving of the boundary line and the setting of the bezel area are performed when a bezel setting mode is turned on.

3. The method of claim 1, wherein the bezel area is set to an input interface lock state that locks an input interface through the bezel area.

4. The method of claim 1, wherein the bezel area is set to a user interface lock state that locks an input interface and an output interface through the bezel area.

5. The method of claim 4, further comprising:
adjusting a display screen size to match a size of a remaining area excluding the bezel area from the touch screen.

6. A method of providing a flexible bezel in an apparatus including a touch screen display, the method comprising:
detecting dragging of a boundary line of at least one side of a touch screen of the touch screen display;
moving the boundary line of the at least one side, including the side corresponding to the dragging, according to the dragging; and
setting a touch screen area located between the moved boundary line and a default boundary line as a bezel area.

7. The method of claim 6, wherein the moving of the boundary line and the setting of the bezel area are performed when a bezel setting mode is turned on.

8. The method of claim 6, wherein the bezel area is set to an input interface lock state that locks an input interface through the bezel area.

9. The method of claim 6, wherein the bezel area is set to a user interface lock state that locks an input interface and an output interface through the bezel area.

10. The method of claim 9, further comprising:
adjusting a display screen size to match a size of a remaining area excluding the bezel area from the touch screen.

11. The method of claim 6, wherein, when the touch screen is in a quadrangular shape and a boundary line of the at least one side of the touch screen is dragged, the moving of the boundary line is performed based on a predefined move mode from among modes comprising:
a first move mode to move only the boundary line of the dragged side;
a second move mode to move the boundary line of the dragged side and a boundary line of a side connected to the dragged side;
a third move mode to move the boundary line of the dragged side and a boundary line of a subtend side of the dragged side;
a fourth move mode to move the boundary line of the dragged side, the boundary line of a side connected to the dragged side, and the boundary line of the subtend side of the dragged side, or to move the boundary line of the dragged side and two boundary lines of two sides connected to the dragged side; and
a fifth move mode to move all the boundary lines of the sides of the touch screen.

12. The method of claim 6, wherein, when the touch screen is in a quadrangular shape and boundary lines of two subtend sides or two connected sides from among the sides of the touch screen are dragged together, the moving of the boundary line is performed based on a predefined move mode from among modes comprising:
a first move mode to move only the boundary lines of the dragged sides;
a second move mode to move the boundary lines of the dragged sides and a boundary line of a side connected to the dragged two sides; and
a third move mode to move all the boundary lines of the sides of the touch screen.

13. An apparatus for providing a flexible bezel, the apparatus comprising:
a touch screen display; and
a controller configured to move a boundary line according to a dragging and to set a touch screen area located between the moved boundary line and a default boundary line as a bezel area, when the dragging of the boundary line of a touch screen is detected on the touch screen of the touch screen display.

14. The apparatus of claim 13, wherein the controller performs the moving of the boundary line and the setting of the bezel area when a bezel setting mode is turned on.

15. The apparatus of claim 13, wherein the controller sets the bezel area to an input interface lock state that locks an input interface through the bezel area.

16. The apparatus of claim 13, wherein the controller sets the bezel area to a user interface lock state that locks an input interface and an output interface through the bezel area.

17. The apparatus of claim 16, wherein the controller adjusts a display screen size to match a size of a remaining area excluding the bezel area from the touch screen.

18. An apparatus for providing a flexible bezel, the apparatus comprising:
a touch screen display; and
a controller configured to move a boundary line of at least one side including a side corresponding to dragging according to the dragging and to set a touch screen area located between the moved boundary line and a default boundary line as a bezel area, when the dragging of the boundary line of the at least one side of the touch screen is detected on the touch screen of the touch screen display.

19. The apparatus of claim 18, wherein the controller performs the moving of the boundary line and the setting of the bezel area when a bezel setting mode is turned on.

20. The apparatus of claim 18, wherein the controller sets the bezel area to an input interface lock state that locks an input interface through the bezel area.

21. The apparatus of claim 18, wherein the controller sets the bezel area to a user interface lock state that locks an input interface and an output interface through the bezel area.

22. The apparatus of claim 21, wherein the controller adjusts a display screen size to match a size of a remaining area excluding the bezel area on the touch screen.

23. The apparatus of claim 18, wherein, when the touch screen is in a quadrangular shape and the boundary line of the at least one side of the touch screen is dragged, the controller moves the boundary line based on a predefined move mode from among modes comprising:
a first move mode to move the boundary line of the dragged side;
a second move mode to move the boundary line of the dragged side and a boundary line of a side connected to the dragged side;
a third move mode to move the boundary line of the dragged side and a boundary line of a subtend side of the dragged side;
a fourth move mode to move the boundary line of the dragged side, the boundary line of a side connected to the dragged side, and the boundary line of the subtend side of the dragged side, or to move the boundary line of the dragged side and two boundary lines of two sides connected to the dragged side; and
a fifth move mode to move all the boundary lines of the sides of the touch screen.

24. The apparatus of claim 18, wherein, when the touch screen is in a quadrangular shape and boundary lines of two subtend sides or two connected sides from among the sides of the touch screen are dragged together, the controller moves the boundary lines based on a predefined move mode from among modes comprising:
a first move mode to move only the boundary lines of the two dragged sides;
a second move mode to move the boundary lines of the two dragged sides and a boundary line of a side connected to the two dragged sides; and
a third move mode to move all the boundary lines of the sides of the touch screen.
